(19) United States
(12) Patent Application Publication
(10) Pub. No.: US 2014/0310793 A1
(43) Pub. Date: Oct. 16, 2014

(54) APPLICATION LOGIN METHOD AND APPARATUS, AND MOBILE TERMINAL THEREFOR

(71) Applicant: Tencent Technology (Shenzhen) Company Limited, Shenzhen (CN)

(72) Inventors: Shichao Liu, Beijing (CN); Pan XU, Beijing (CN); Kai LI, Beijing (CN); Hongwei YUWEN, Beijing (CN); Meng HUANG, Beijing (CN); Wei ZHANG, Beijing (CN); Yi ZHAO, Beijing (CN)

(21) Appl. No.: 14/316,703

(22) Filed: Jun. 26, 2014

Related U.S. Application Data
(63) Continuation of application No. PCT/CN2012/085980, filed on Dec. 5, 2012.

(30) Foreign Application Priority Data
Dec. 28, 2011 (CN) 201110448678.2

(51) Int. Cl. H04L 29/06

(52) U.S. Cl. CPC H04L 63/08; H04L 63/0823; H04L 63/083
USPC 726/8

(57) ABSTRACT

The present disclosure, pertaining to the field of network applications, discloses an application login method and apparatus, and a mobile terminal therefor. The method includes: verifying an application upon receiving from a user a request for logging in to the application; returning at least one locally stored account if the application is successfully verified; and logging in to the application using an account upon detecting that the user selects the account from the at least one locally stored account. The apparatus includes: a receiving module, a verifying module, a returning module, and a login module. According to the present disclosure, upon receiving from a user a request for logging in to an application, a terminal verifies the application; when the application is successfully verified, the terminal provides a stored account for the application, such that a plurality of applications provided by the same operator share the same account and password. This not only improves utilization rate of resources, but also enhances convenience degree.

This application is a continuation application of International Application No. PCT/CN2012/085980, filed Dec. 5, 2012, which claims the benefit of Chinese Patent Application No. 201110448678.2, filed on Dec. 28, 2011. Each of these prior applications is incorporated herein by reference in its entirety.

### TECHNICAL FIELD

The present disclosure relates to the field of computer technologies, and in particular, to an application login method and apparatus, and a mobile terminal therefor.

### BACKGROUND

In recent years, with dramatic development of wireless technologies, smart phones and tablet computers are more and more widely used. Accordingly, various applications are being released A large number of personal computer (PC) services are transplanted to mobile devices, such that work that can only be carried out on the PCs originally may be done on the mobile devices. When users use different applications or access various third-party applications providing diversified services on the mobile terminals, for example, instant messaging applications and game applications, accounts and passwords need to be entered for logging in to these applications.

After analyzing the prior art, the inventors find that the prior art has at least the following disadvantages:

At present, the same network operator generally provides a plurality of mobile terminal-specific applications. Each of these applications has an independent account system. The account systems of these applications are incompatible with each other. To be specific, each application records only account information used for logging in to the same, but is incapable of recording account information of other applications. This causes great inconvenience to users.

### SUMMARY

Embodiments of the present disclosure provide an application login method and apparatus, and a mobile terminal therefor. The technical solutions are as follows:

An embodiment of the present disclosure provides an application login method, including:
verifying an application upon receiving from a user a request for logging in to the application;
returning at least one locally stored account if the application is successfully verified; and
logging in to the application using an account upon detecting that the user selects the account from the at least one locally stored account.

Further, the verifying an application specifically includes:
acquiring an application identifier and a digital certificate of the application;
sending a verification request message to a server, the verification request message carrying at least the application identifier and the digital certificate; and
receiving and storing a verification result returned after the server verifies the application according to the verification request message.

Further, after the acquiring an application identifier and a digital certificate of the application, and prior to the sending a verification request message to a server, the method further includes:
judging whether a locally stored verification result list includes a verification result corresponding to the application identifier;
if true, acquiring the verification result corresponding to the application identifier; and
otherwise, sending the verification request message to the server.

Further, the logging in to the application using an account upon detecting that the user selects the account from the at least one locally stored account specifically includes:
upon detecting that the user selects an account from the at least one locally stored account, extracting the selected account from the at least one locally stored account, and acquiring a password corresponding to the selected account; and
logging in to the application using the selected account and the password corresponding thereto as a login account and a password of the application.

Further, if the password corresponding to the selected account is an encrypted password, the acquiring a password corresponding to the selected account specifically includes: acquiring an encrypted password corresponding to the selected account, and decrypting the encrypted password.

Further, if the application is successfully verified, the method further includes:
receiving an account and a password entered by the user, and sending the account and the password entered by the user to an application server for acknowledgment; and
upon receiving an acknowledgment message from the application server, logging in to the application using the account and the password entered by the user as a login account and a password of the application, and locally storing the account and the password entered by the user.

Further, the locally storing the account and the password entered by the user includes:
encrypting the password entered by the user; and
locally storing the account entered by the user and the encrypted password.

An embodiment of the present disclosure provides an application login apparatus, including:
a receiving module, configured to receive an application login request from a user;
a verifying module, configured to verify the application;
a returning module, configured to return at least one locally stored account if the application is successfully verified; and

a login module, configured to log in to the application using an account upon detecting that the user selects the account from the at least one locally stored account.

The verifying module includes:
a first acquiring unit, configured to acquire an application identifier and a digital certificate of the application;
a sending unit, configured to send a verification request message to a server, the verification request message carrying at least the application identifier and the digital certificate; and
a storing unit, configured to receive and store a verification result returned after the server verifies the application according to the verification request message.

The verifying module further includes:
a judging unit, configured to judge whether a locally stored verification result list comprises a verification result corresponding to the application identifier; and
a second acquiring unit, configured to acquire the verification result when the judging unit determines that the locally stored verification result list includes the verification result corresponding to the application identifier;
where the sending unit is further configured to send the verification request message to the server when the judging unit determines that the locally stored verification result list does not include the verification result corresponding to the application identifier.

The login module includes:
a third acquiring unit, configured to: upon detecting that the user selects an account from the at least one locally stored account, extract the selected account from the at least one locally stored account, and acquire a password corresponding to the selected account; and
a login unit, configured to log in to the application using the selected account and the password corresponding thereto acquired by the third acquiring unit as a login account and a password of the application.

Further, if the password corresponding to the selected account is an encrypted password, the third acquiring unit is specifically configured to: upon detecting that the user selects an account from the at least one locally stored account, extract the selected account from the at least one locally stored account, acquire a password corresponding to the selected account, and decrypt the encrypted password.

Further, the receiving module is further configured to receive an account and a password entered by the user.

The apparatus further includes:
a sending module, configured to send the account and the password entered by the user to an application server for acknowledgment; and
a storing module, configured to: upon receiving an acknowledgment message from the application server, log in to the application using the account and the password entered by the user as a login account and a password of the application, and locally store the account and the password entered by the user.

The storing module includes:
an encrypting unit, configured to encrypt the password entered by the user; and
a storing unit, configured to locally store the account entered by the user and the encrypted password.

An embodiment of the present disclosure provides a mobile terminal, where the mobile terminal includes the above-described application login apparatus.

The technical solutions according to the embodiments of the present disclosure achieve the following beneficial effects:

According to the present disclosure, a terminal verifies an application upon receiving from a user a request for logging in to the application; the terminal provides a stored account for the application if the application is successfully verified, such that a plurality of applications provided by the same operator share the same account and password. This not only improves utilization rate of resources, but also enhances convenience degree.

### BRIEF DESCRIPTION OF THE DRAWINGS

To illustrate the technical solutions in the embodiments of the present disclosure or in the prior art more clearly, the accompanying drawings required for describing the embodiments or the prior art will be described as follows. Apparently, the accompanying drawings in the following description merely show some embodiments of the present disclosure, and persons of ordinary skill in the art may derive other drawings based on these accompanying drawings without creative efforts.

FIG. 1 is a flowchart of an application login method according to an embodiment of the present disclosure;

FIG. 2 is a flowchart of an application login method according to an embodiment of the present disclosure;

FIG. 3 is a flowchart of an application login method according to an embodiment of the present disclosure;

FIG. 4 is a schematic structural diagram of an application login apparatus according to an embodiment of the present disclosure; and

FIG. 5 is a schematic structural diagram of an application login apparatus according to an embodiment of the present disclosure.

### DETAILED DESCRIPTION

To make the objectives, technical solutions, and advantages of the present disclosure clearer, the embodiments of the present disclosure are described in detail below with reference to the accompanying drawings.

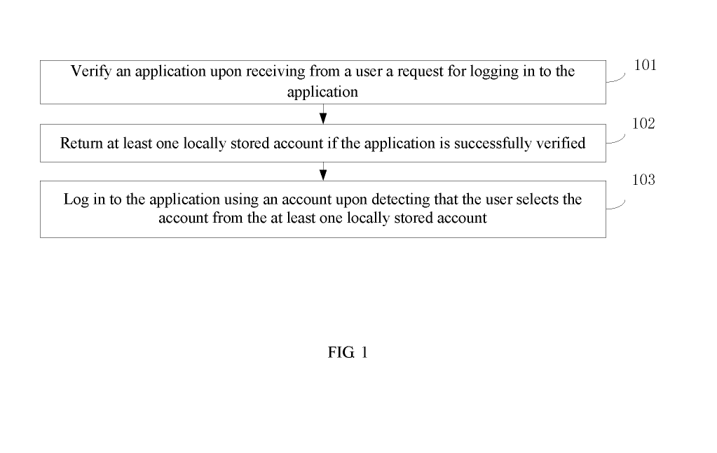

FIG. 1 is a flowchart of an application login method according to an embodiment of the present disclosure. The execution subject of this embodiment may be a terminal, where the terminal may be a mobile terminal, including but not limited to a mobile phone, an Moving Picture Experts Group Audio Layer III (MP3) player, or a Personal Digital Assistant (PDA). Referring to FIG. 1, this embodiment includes:

101. verifying an application upon receiving from a user a request for logging in to the application;

102. returning at least one locally stored account if the application is successfully verified; and

103. logging in to the application using an account upon detecting that the user selects the account from the at least one locally stored account .

Further, the verifying an application specifically includes:
acquiring an application identifier and a digital certificate of the application;
sending a verification request message to a server, the verification request message carrying at least the application identifier and the digital certificate; and
receiving and storing a verification result returned after the server verifies the application according to the verification request message.

Further, after the acquiring an application identifier and a digital certificate of the application, and prior to the sending a verification request message to a server, the method further includes:
judging whether a locally stored verification result list comprises a verification result corresponding to the application identifier;
if true, acquiring the verification result corresponding to the application identifier; and otherwise, sending the verification request message to the server.

Further, the logging in to the application using an account upon detecting that the user selects the account from the at least one locally stored account, specifically includes:
upon detecting that the user selects an account from the at least one locally stored account, extracting the selected account from the at least one locally stored account, and acquiring a password corresponding to the selected account; and
logging in to the application using the selected account and the password corresponding thereto as a login account and a password of the application.

Further, if the password corresponding to the selected account is an encrypted password, the acquiring a password corresponding to the selected account specifically includes: acquiring an encrypted password corresponding to the selected account, and decrypting the encrypted password.

Further, if the application is successfully verified, the method further includes: receiving an account and a password entered by the user, and sending the account and the password entered by the user to an application server for acknowledgment; and
upon receiving an acknowledgment message from the application server, logging in to the application using the account and the password entered by the user as a login account and a password of the application, and locally storing the account and the password entered by the user.

Further, the locally storing the account and the password entered by the user includes:
encrypting the password entered by the user; and
locally storing the account entered by the user and the encrypted password.

According to the method provided in this embodiment, a terminal verifies an application upon receiving from a user a request for logging in to the application; the terminal provides a stored account for the application if the application is successfully verified, such that a plurality of applications provided by the same operator share the same account and password. This not only improves utilization rate of resources, but also enhances convenience degree.

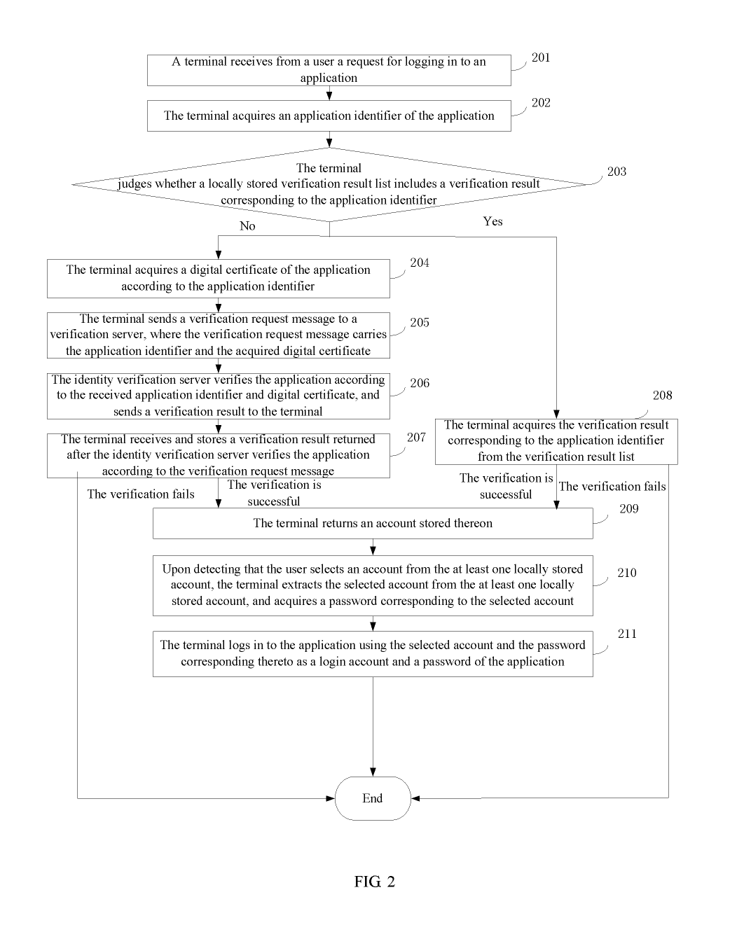

FIG. 2 is a flowchart of an application login method according to an embodiment of the present disclosure. The execution subjects of this embodiment are a terminal and a server, where the terminal may be a PC or a mobile terminal, such as a mobile phone, an MP3 player, or a PDA, and the server may be an identity verification server. Referring to FIG. 2, this embodiment includes:

201. A terminal receives from a user a request for logging in to an application.

In this embodiment, a plurality of applications may be installed and run on the terminal, for example, an instant messaging application, a personal zone application, a Weibo application, or a game application. The plurality of applications may be logged in to using the same user name and password. For example, the same user name and password may be used to log in to the personal zone application or the game application.

202. The terminal acquires an application identifier of the application.

A person skilled in the art may know that each of the applications is assigned an application identifier (APP ID), where the application identifier is one-to-one corresponding to the application. The application identifier may be configured by a person skilled in the art in the application, or may be carried in any of various requests initiated with respect to operations on the application. For example, in this embodiment, the application identifier is carried in the request for logging in to the application.

203. The terminal judges whether a locally stored verification result list includes a verification result corresponding to the application identifier.

If a verification result corresponding to the application identifier is included, step 208 is performed.

If no verification result corresponding to the application identifier is included, step 204 is performed.

In this embodiment, the verification result list stored on the terminal is used for storing application identifiers, and storing verification results returned after the identity verification server verifies applications identified by the application identifiers. Preferably, the verification result list may also be a Hash table. The verification result list is set on the terminal, such that the application does not need to be verified by the identity verification server each time. This prevents delay caused due to network congestion.

204. The terminal acquires a digital certificate of the application according to the application identifier.

In this embodiment, upon acquiring the application identifier of the application, the terminal may query the digital certificate of the corresponding application according to the application identifier. The digital certificate may be an encrypted character string acquired by encrypting, using a predetermined encryption algorithm, an application signature of the queried application. In practice, the predetermined encryption algorithm may be any of various conventional encryption algorithms. For example, the predetermined encryption algorithm may be the Message-Digest Algorithm 5 (MD5), and the digital certificate may be specifically an MD5 string. In this step, the terminal may invoke a system Application Programming Interface (API) to perform the process of acquiring the digital certificate of the application. The process may include: invoking the system API to query the application corresponding to the application identifier on the terminal; acquiring the application signature of the application program, and encrypting the application signature using the predetermined encryption algorithm to acquire the digital certificate of the application.

205. The terminal sends a verification request message to an identity verification server, where the verification request message carries the application identifier and the acquired digital certificate.

In this embodiment, step 205 is a process of requesting the identity verification server by the terminal to verify the application signature of the application. In this step, the terminal sends a verification request message to a verification server, where the verification request message carries the application identifier and the acquired digital certificate. In another embodiment of the present disclosure, the verification request message may further carry other content, such as application's content actually requested by the user (for example, account information of the login request, and the like); the actually requested content is sent to the identity verification server together with the verification request message. This prevents a time-consuming signature verification process caused due to network delays, and further reduces waiting time of the user. In practice, a person skilled in the art or users may set as whether the verification request message carries other content. The set verification request message needs to be corresponding to the verification algorithm configured on the identity verification server.

The identity verification server refers to a server having an identity verification function. Herein the identity verification server may be an independent server or a function module of a server.

In another embodiment, after steps 201 and 202 are performed, step 203 may not necessarily be performed, but step 204 and the subsequent steps may be performed. The application is logged in to according to the verification result fed back in real time by the identity verification server, thereby ensuring security of the application.

206. The identity verification server verifies the application according to the received application identifier and digital certificate, and sends a verification result to the terminal.

In this embodiment, the verification result may indicate successful verification or failed verification. The identity verification server receives the verification request message, and compares locally stored application identifier and digital certificate with the application identifier and the digital certificate carried in the verification request message; if the received application identifier and digital certificate are consistent with the locally stored application identifier and digital certificate, the identity verification server determines that the application is an authorized application, and the verification is successful; and if the received application identifier and digital certificate are inconsistent with the locally stored application identifier and digital certificate, the identity verification server determines that the application is an unauthorized application, and the verification fails.

207. The terminal receives and stores the verification result returned after the identity verification server verifies the application according to the verification request message; and if the verification is successful, step 209 is performed.

When the terminal receives the verification result from the identity verification server, if the verification result indicates that the verification is successful, the application is an authorized application, and an account and a password stored on the terminal may be used for logging in to the application; whereas if the verification result indicates that the verification fails, the application is an unauthorized application, and an account and a password stored on the terminal may not be used.

Further, the terminal correspondingly stores the verification result and the application identifier in the verification result list, such that the verification result is directly acquired when a request for logging in to the application is received again. This simplifies the process and prevents verification delay caused due to unreachability to the identity verification server or network congestion.

208. The terminal acquires the verification result corresponding to the application identifier from the verification result list stored on the terminal; and if the verification is successful, step 209 is performed.

If the verification result list stored on the terminal includes the application result corresponding to the application identifier, the application has ever been verified on the identity verification server, and the verification result thereof has been stored on the terminal. In this case, the application does not need to be verified again on the identity verification server.

209. The terminal returns at least one account stored on the terminal.

In this embodiment, the at least one locally stored account is the account using which the application of the terminal has been logged in to or the account locally configured by the user; the account stored on the terminal is one-to-one corresponding to the encrypted password. In this way, when it is verified that the terminal is an authorized one, an account and a password are provided for the application. Using a case where the requested application is a game application as an example, if the terminal is further installed with an instant messaging application or a Weibo application, then an account and a password may be stored when the instant messaging application has ever been logged in to. In this case, when a request for logging in to the game application, and after the game application is successfully verified, the account of the instant messaging application or Weibo application stored on the terminal is acquired, and then provided to the user. A person skilled in the art may acquire that the account may be provided to the user in a plurality of manners, for example, in a manner of list display or prompts. It should be noted that when the verification results indicates that the verification fails, the application login process ends.

210. Upon detecting that the user selects an account from at least one locally stored account, the terminal extracts the selected account from the at least one locally stored account, and acquires a password corresponding to the selected account.

In this embodiment, the terminal may store one or a plurality of accounts, and in the initial stage, even no account. When the terminal stores one or a plurality of accounts, the user may extract or select one account from the one or plurality of accounts, and logs in to the application using the selected account. In this step, when the user selects one account from the at least one locally stored account, extract the selected account from the at least one locally stored account, and acquires a password corresponding to the selected account.

211. The terminal logs in to the application using the selected account and the password corresponding thereto as a login account and a password of the application.

In this embodiment, if the password corresponding to the selected account is an encrypted password, the acquiring a password corresponding to the selected account specifically includes: acquiring an encrypted password corresponding to the selected account, and decrypting the encrypted password. The encrypted password may be a password encrypted using the MD5 and/or the Tiny Encryption Algorithm (TEA). In this step, the encrypted password is decrypted according to the encryption algorithm. For example, if a password is double-encrypted using the MD5 and the TEA, in this step, the password decryption is based on the MD5 and TEA.

The login in this embodiment refers to a process of sending a request for logging in to a server to the application server of the application, where the request for logging in to a server carries a login account and a password, and making a response to the request by the application server. This process pertains to the prior art, which is not described herein any further.

Further, upon receiving a default setting request, the terminal sets the account and the password, among the at least one locally stored account and password, indicated in the default setting request are set as default account and password, such that upon receiving a request for logging in to an application, and successfully verifying the application, the terminal logs in to the application using the default account and password as a login account and a password. According to this embodiment, a terminal verifies an application upon receiving from a user a request for logging in to the application; the terminal provides a stored account for the application is the application is successfully verified, such that a plurality of applications provided by the same operator share the same account and password. This not only improves utilization rate of resources, but also enhances convenience degree.

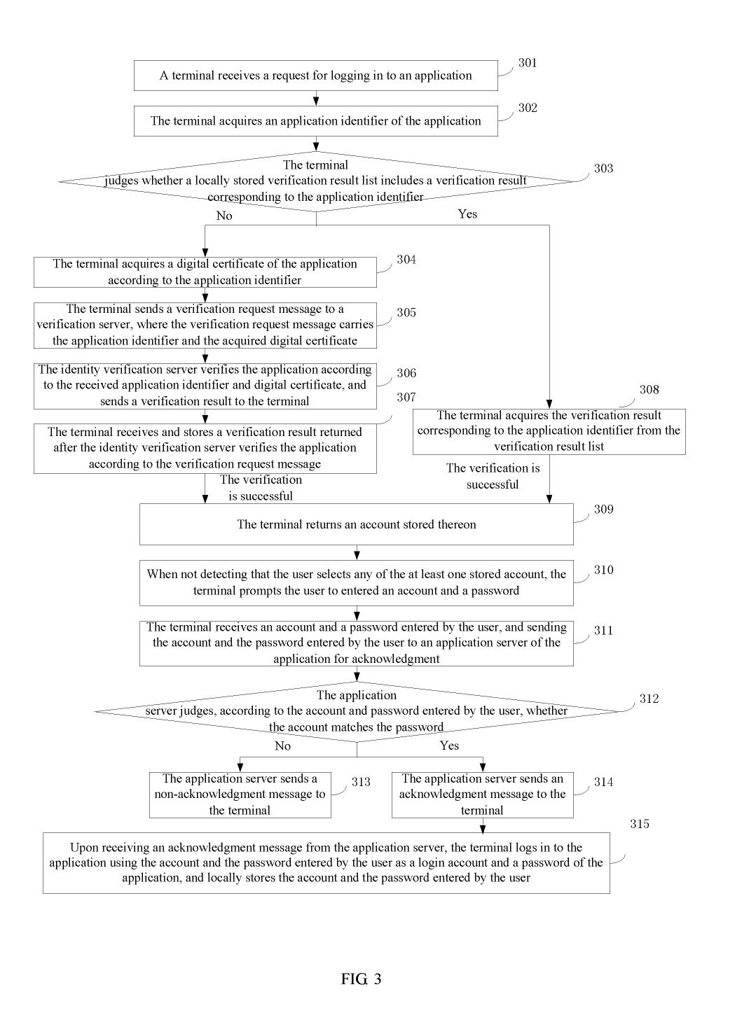

FIG. 3 is a flowchart of an application login method according to an embodiment of the present disclosure. The execution subject of this embodiment is a terminal, where the terminal may be a PC, or a mobile terminal such as a mobile phone, an MP3 player, or a PDA. Referring to FIG. 3, this embodiment includes:

301. A terminal receives a request for logging in to an application.

302. The terminal acquires an application identifier of the application.

303. The terminal judges whether a locally stored verification result list includes a verification result corresponding to the application identifier.

If a verification result corresponding to the application identifier is included, step 308 is performed.

If no verification result corresponding to the application identifier is included, step 304 is performed.

304. The terminal acquires a digital certificate of the application according to the application identifier.

305. The terminal sends a verification request message to a verification server, where the verification request message carries the application identifier and the acquired digital certificate.

306. The identity verification server verifies the application according to the received application identifier and digital certificate, and sends a verification result to the terminal.

307. The terminal receives and stores the verification result returned after the identity verification server verifies the application according to the verification request message; and if the verification is successful, the process skips to step 309.

308. The terminal acquires the verification result corresponding to the application identifier from the verification result list stored on the terminal; and if the verification is successful, step 209 is performed.

309. The terminal returns an account stored thereon.

Steps 301-309 are similar to steps 201-209 in the embodiment illustrated in FIG. 2, which are not described herein any further.

310. The terminal prompts the user to entered an account and a password upon not detecting that the user selects an account from the at least one locally stored account.

In this embodiment, if the accounts displayed on the terminal do not include the account desired by the terminal user, or the terminal currently stores no account and password, with respect to the application verified as authorized, user's selection of any of the at least locally stored account may not be detected. Therefore, the terminal user needs to enter an account and a password for logging in to the application.

311. The terminal receives an account and a password entered by the user, and sending the account and the password entered by the user to an application server of the application for acknowledgment.

In practice, the account entered by the user may not match the password entered by the user, and the terminal needs to log in to the application server using the account and the password entered by the user to check whether the account matches the password. This process is similar to the login process described in step 212, which is not described herein any further.

312. The application server judges, according to the account and the password entered by the user, whether the account matches the password.

If the account matches the password, step 314 is performed.

If the account does not match the password, step 313 is performed.

A person skilled in the art may acquire that the specific matching process pertains to the prior art, which is not described herein any further.

313. The application server sends a non-acknowledgment message to the terminal, where the non-acknowledgment message is used for notifying the terminal that the account does not match the password; and the process ends.

Preferably, upon receiving the non-acknowledgment message, the terminal acquires that the account does not match the password, and prompts the terminal user about the matching result. Such a prompt is generally “unavailable account” or “incorrect password”. Further, the terminal may prompt the user to re-enter the account and the password.

314. The application server sends an acknowledgment message to the terminal, where the acknowledgment message is used for notifying the terminal that the account matches the password.

A person skilled in the art may acquire that when the account matches the password, the terminal is capable of logging in to the application server.

315. Upon receiving the acknowledgment message from the application server, the terminal logs in to the application using the account and the password entered by the user as a login account and a password of the application, and locally stores the account and the password entered by the user.

The storing the account and the password entered by the user includes: encrypting the password entered by the user; and correspondingly storing the account entered by the user and the encrypted password locally. Specifically, a key corresponding to the application is acquired according to a key serial number of the application; the password entered by the user is decrypted according to the key corresponding to the application; and the decrypted password entered by the user is decrypted using a predetermined key; and the account entered by the user and the encrypted password are stored. It should be noted that each of the authorized application on the terminal corresponds to a key serial number (KEY_ID) of a key, where the serial number corresponds to a 16-byte key. Upon receiving the account and the password entered by the user, the terminal performs MD5 encryption for the password, and further encrypts the password using the key corresponding to the application. If the account and the password entered by the user need to be stored, the terminal searches for the corresponding key according to the key serial number, decrypts the encrypted password according to the corresponding key, encrypts the decrypted password using a specific key, and finally stores the account entered by the user and the password encrypted using the specific key. The encryption and decryption processes pertain to the prior art, which are not described herein any further. During storage of the account and the password, encryption using a specific key is to prevent key loss due to code decompilation, and prevent another program from maliciously invoking a library file. Therefore, the code is packaged into a C++ library file, arrays storing keys are mixedly arranged to prevent the keys from being stored in contiguous memory areas.

Further, upon receiving an instruction as not storing the account and the password, the terminal does not store the account and the password entered by the user. The terminal may or may not store the account and the password entered by the user. When a terminal user determines to store the account and the password, i.e., the terminal receives an instruction as storing the account and the password, the terminal stores the account and the password. When the terminal user determines not to store the account and the password, i.e., the terminal receives an instruction as not storing the account and the password, the terminal does not store the account and the password.

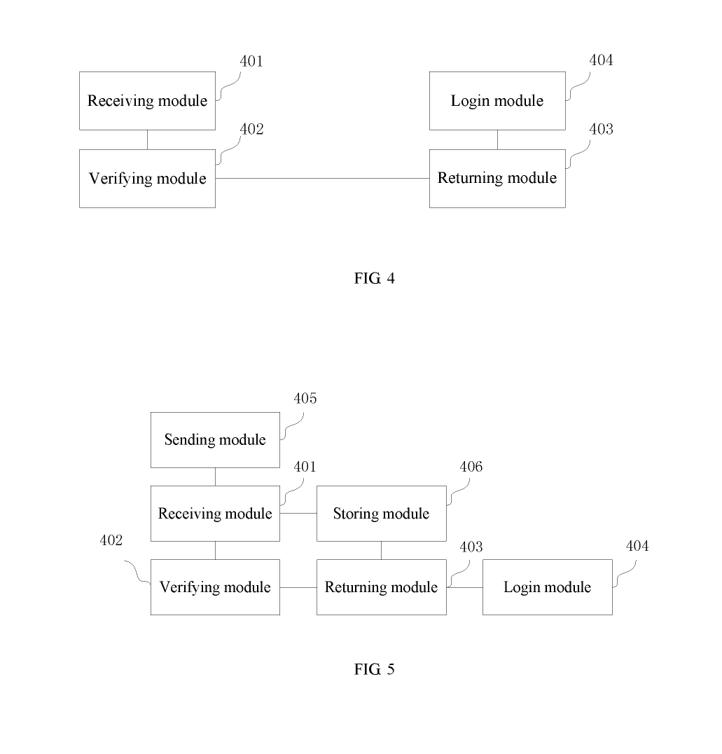

FIG. 4 is a schematic structural diagram of an application login apparatus according to an embodiment of the present disclosure. Referring to FIG. 4, the apparatus includes:
a receiving module 401, configured to receive an application login request from a user;
a verifying module 402, configured to verify the application;
a returning module 403, configured to return at least one locally stored account if the application is successfully verified; and
a login module 404, configured to log in to the application using an account upon detecting that the user selects the account from the at least one locally stored account.

In this embodiment, the at least one locally stored account is the account using which the application of the terminal has been logged in to or the account locally configured by the user; the account stored on the terminal is one-to-one corresponding to the encrypted password. In this way, when it is verified that the terminal is an authorized one, an account and a password are provided for the application.

Further, upon receiving a default setting request, the terminal sets the account and the password, among the at least one locally stored account and password, indicated in the default setting request as a default account and password, such that upon receiving a request for logging in to an application, and successfully verifying the application, the terminal logs in to the application using the default account and password as a login account and a password. In an embodiment, the verifying module 402 includes:
a first acquiring unit, configured to acquire an application identifier and a digital certificate of the application;
a sending unit, configured to send a verification request message to a server, the verification request message carrying at least the application identifier and the digital certificate; and
a storing unit, configured to receive and store a verification result returned after the server verifies the application according to the verification request message. In this embodiment, after acquiring the application identifier of the application, the first acquiring unit queries an application signature corresponding to the application identifier according to the application identifier, and acquires, by calculation using a predetermined encryption algorithm, the digital certificate of the application according to the application signature.

In another embodiment, the verifying module 402 includes:
a judging unit, configured to judge whether a locally stored verification result list comprises a verification result corresponding to the application identifier; and
a second acquiring unit, configured to acquire the verification result when the judging unit determines that the locally stored verification result list includes the verification result corresponding to the application identifier,
where the sending unit is further configured to: send the verification request message to the server when the judging unit determines that the locally stored verification result list does not include the verification result corresponding to the application identifier.

Further, the verification result and the application identifier are correspondingly stored in the verification result list, such that the verification result is directly acquired when a request for logging in to the application is received again. This simplifies the process and prevents verification delay caused due to unreachability to the identity verification server or network congestion.

The login module 404 includes:
a third acquiring unit, configured to: upon detecting that the user selects an account from the at least one locally stored account, extract the selected account from the at least one locally stored account, and acquire a password corresponding to the selected account; and
a login unit, configured to log in to the application using the selected account and password corresponding thereto acquired by the third acquiring unit as a login account and a password of the application.

If the password corresponding to the selected account is an encrypted password, the third acquiring unit is specifically configured to: upon detecting that the user selects an account from the at least one locally stored account, extract the selected account from the at least one locally stored account, acquire a password corresponding to the selected account, and decrypt the encrypted password.

In another embodiment, the receiving module 401 is further configured to receive an account and a password entered by the user.

Referring to FIG. 5, the apparatus further includes:
a sending module 405, configured to send the account and the password entered by the user to an application server for acknowledgment; and
a storing module 406, configured to: upon receiving an acknowledgment message from the application server, log in to the application using the account and the password entered by the user as a login account and a password of the application, and locally store the account and the password entered by the user.

The storing module 406 includes:
an encrypting unit, configured to encrypt the password entered by the user; and
a storing unit, configured to locally store the account entered by the user and the encrypted password.

The storing unit is specifically configured to: acquire a key corresponding to the application according to a key serial number of the application; decrypt, according to the key corresponding to the application, the password entered by the user; encrypt, using a predetermined key, the decrypted password entered by the user; and store the account entered by the user and the encrypted password.

The apparatus provided in this embodiment is based on the same inventive concept as the method embodiments, where the detailed implementation is elaborated in the method embodiments of the present disclosure, which is not described herein any further. An embodiment of the present disclosure provides an application login system, where the system includes at least:
a mobile terminal and an identity verification server.

The mobile terminal is configured to: verify an application upon receiving from a user a request for logging in to the application,; return at least one locally stored account if the application is successfully verified,; and log in to the application using an account upon detecting that the user selects the account from the at least one locally stored account.

The identity verification server is configured to: receive the verification request message; verify the application according to the verification request message; and return a verification result.

All or part of the technical solutions according to the embodiments of the present disclosure may be implemented by a program instructing relevant hardware. The programs may be stored in a non-transitory computer-readable storage medium and may be executed by at least one processor. The storage medium includes various mediums capable of storing program code, such as a read only memory (ROM), a random access memory (RAM), a magnetic disk, or a compact disc read-only memory (CD-ROM).

Described above are merely preferred embodiments of the present disclosure, but are not intended to limit the present disclosure. Any modification, equivalent replacement, or improvement made without departing from the spirit and principle of the present disclosure should fall within the protection scope of the present disclosure.

What is claimed is:

1. An application login method, comprising:
verifying an application upon receiving from a user a request for logging in to the application;
returning at least one locally stored account if the application is successfully verified; and
logging in to the application using an account upon detecting that the user selects the account from the at least one locally stored account.

2. The method according to claim 1, wherein the verifying an application specifically comprises:
acquiring an application identifier and a digital certificate of the application;
sending a verification request message to a server, the verification request message carrying at least the application identifier and the digital certificate; and
receiving and storing a verification result returned after the server verifies the application according to the verification request message.

3. The method according to claim 2, wherein after the acquiring an application identifier and a digital certificate of the application, and prior to the sending a verification request message to a server, the method further comprises:
judging whether a locally stored verification result list comprises a verification result corresponding to the application identifier;
if true, acquiring the verification result corresponding to the application identifier; and
otherwise, performing the step of sending the verification request message to the server.

4. The method according to any one of claims 1 to 3, wherein the logging in to the application using an account upon detecting that the user selects the account from the at least one locally stored account specifically comprises:
upon detecting that the user selects the account from the at least one locally stored account, extracting the selected account from the at least one locally stored account, and acquiring a password corresponding to the selected account; and
logging in to the application using the selected account and the password corresponding thereto as a login account and a password of the application.

5. The method according to claim 4, wherein if the password corresponding to the selected account is an encrypted password, the acquiring a password corresponding to the selected account specifically comprises: acquiring an encrypted password corresponding to the selected account, and decrypting the encrypted password.

6. The method according to any one of claims 1 to 3, wherein if the application is successfully verified, the method further comprises:
receiving an account and a password entered by the user, and sending the account and the password entered by the user to an application server for acknowledgment; and
upon receiving an acknowledgment message from the application server, logging in to the application using the account and the password entered by the user as a login account and a password of the application, and locally storing the account and the password entered by the user.

7. The method according to claim 6, wherein the locally storing the account and the password entered by the user comprises:
encrypting the password entered by the user; and
locally storing the account entered by the user and the encrypted password.

8. An application login apparatus, comprising:
a receiving module, configured to receive an application login request from a user;
a verifying module, configured to verify the application;
a returning module, configured to return at least one locally stored account if the application is successfully verified; and
a login module, configured to log in to the application using an account upon detecting that the user selects the account from the at least one locally stored account.

9. The apparatus according to claim 8, wherein the verifying module comprises:
a first acquiring unit, configured to acquire an application identifier and a digital certificate of the application;
a sending unit, configured to send a verification request message to a server, the verification request message carrying at least the application identifier and the digital certificate; and
a storing unit, configured to receive and store a verification result returned after the server verifies the application according to the verification request message.

10. The apparatus according to claim 9, wherein the verifying module further comprises:
a judging unit, configured to judge whether a locally stored verification result list comprises a verification result corresponding to the application identifier; and
a second acquiring unit, configured to acquire the verification result when the judging unit determines that the locally stored verification result list comprises the verification result corresponding to the application identifier,;
wherein the sending unit is further configured to send the verification request message to the server when the judging unit determines that the locally stored verification result list does not comprise the verification result corresponding to the application identifier.

11. The apparatus according to any one of claims 8 to 10, wherein the login module comprises:
a third acquiring unit, configured to: upon detecting that the user selects an account from the at least one locally stored account, extract the selected account from the at least one locally stored account, and acquire a password corresponding to the selected account; and
a login unit, configured to log in to the application using the selected account and the password corresponding thereto acquired by the third acquiring unit as a login account and a password of the application.

12. The communication device according to claim 8, wherein
if the password corresponding to the selected account is an encrypted password, the third acquiring unit is specifically configured to: upon detecting that the user selects an account from the at least one locally stored account, extract the selected account from the at least one locally stored account, acquire a password corresponding to the selected account, and decrypt the encrypted password.

13. The apparatus according to any one of claims 8 to 10, wherein
the receiving module is further configured to receive an account and a password entered by the user; and
the apparatus further comprises:
a sending module, configured to send the account and the password entered by the user to an application server for acknowledgment; and
a storing module, configured to: upon receiving an acknowledgment message from the application server, log in to the application using the account and the password entered by the user as a login account and a password of the application, and locally store the account and the password entered by the user.

14. The apparatus according to claim 13, wherein the storing module comprises:
an encrypting unit, configured to encrypt the password entered by the user; and
a storing unit, configured to locally store the account entered by the user and the encrypted password.

15. A mobile terminal, comprising an application login apparatus according to any one of claims 8 to 14.
